(19) United States
(12) Patent Application Publication
(10) Pub. No.: US 2015/0332872 A1
(43) Pub. Date: Nov. 19, 2015

(54) APPARATUS AND BUTTON

(71) Applicant: Funai Electric Co., Ltd., Osaka (JP)

(72) Inventor: Yoshikazu KONISHI, Osaka (JP)

(21) Appl. No.: 14/710,715

(22) Filed: May 13, 2015

(30) Foreign Application Priority Data
May 14, 2014 (JP) 2014-100562

(51) Int. Cl. H01H 13/02; H01H 3/12

(52) U.S. Cl. CPC H01H 13/023; H01H 3/12; H01H 2219/036; H01H 2219/062; H01H 2231/008; H01H 2231/012; H01H 2231/022

(57) ABSTRACT

An apparatus includes a housing that includes a hole, a tactile switch and an LED disposed within the housing, and a power button including a first molded body and a second molded body made of different types of resin. The first molded body includes a button body supported in a state movable in an axial direction, and disposed such that a front surface of the button body is exposed to the outside of the housing through the hole. The second molded body includes a light guide unit penetrating the button body, a pressing portion disposed at a position spaced away from the light guide unit and projecting toward the tactile switch from a rear surface of the button body, and a connecting portion disposed on the rear surface of the button body and connecting the light guide unit and the pressing portion with each other.

### BACKGROUND OF THE INVENTION

1. Field of the Invention

The present invention relates to an apparatus, and a button provided on this apparatus.

2. Description of the Related Art

An apparatus such as an inkjet printer includes a power button for turning on and off power of the apparatus (for example, see JP 7-282669 A). FIG. 11 is a perspective view illustrating a rear side of a conventional power button. As illustrated in FIG. 11, a power button 102 includes a button body 104, and a pressing portion 106 projecting from a rear surface 104a of the button body 104. The button body 104 and the pressing portion 106 are made of resin and formed integrally with each other. The power button 102 disposed on a housing (not shown) of the apparatus is supported thereon in a freely depressible state. A front surface (surface on the side opposite to the rear surface 104a) of the button body 104 is configured to have a flat shape, and exposed to the outside of the housing through a hole formed in the housing.

A tactile switch (not shown) is provided within the housing to switch power on-off of the apparatus. The tactile switch is so disposed as to face to the pressing portion 106 of the power button 102. With depression of the button body 104 toward the tactile switch, the tactile switch is pressed by the pressing portion 106. As a result, power on-off of the apparatus is switched in accordance with every press of the tactile switch.

As noted above, the pressing portion 106 is provided on the rear surface 104a of the button body 104. In this case, molding defects (such as shrinkage cavities, flow marks, and weld lines) may be produced on the front surface of the button body 104 at a position corresponding to the pressing portion 106 during resin molding of the power button 102. The front surface of the button body 104 is exposed to the external appearance of the housing, wherefore molding defects formed on the front surface of the button body 104 may considerably deteriorate the external appearance of the apparatus.

### SUMMARY OF THE INVENTION

Preferred embodiments of the present invention provide an apparatus and a button capable of preventing deterioration of an external appearance of the apparatus.

An apparatus according to one aspect of various preferred embodiments the present invention includes a housing that includes a hole; a switch disposed within the housing; and a button provided to press the switch, and including a first body made of a first material, and a second body made of a second material different from the first material; wherein an exposed surface is disposed such that at least a portion of the first and second bodies is exposed to outside of the housing through the hole; the second body is disposed on a rear surface of the first body; and the second body is provided to press the switch based on pressing the exposed surface.

The apparatus preferably includes a light source disposed within the housing.

Preferably, the first material is a first molded resin, and the second material is a second molded resin different from the first molded resin.

The first body preferably includes a button body supported in a state movable in an axial direction corresponding to directions of moving closer to and away from the switch, and disposed such that at least a portion of a front surface of the button body is exposed to the outside of the housing through the hole. The second body preferably includes a light guide unit penetrating the button body in the axial direction, along which light guide unit light emitted from the light source is guided toward the outside of the housing; a pressing portion provided to press the switch, disposed at a position spaced away from the light guide unit in a radial direction perpendicular or substantially perpendicular to the axial direction, and projecting toward the switch from a rear surface of the button body; and a connecting portion disposed on the rear surface of the button body, and connecting the light guide unit and the pressing portion with each other.

According to this aspect, the button body constituting the first molded body is made of a material different from a material of the pressing portion constituting the second molded body. In this case, the button body and the pressing portion are hardened at different timings in forming the button. This structure reduces molding defects produced on the front surface of the button body at a position corresponding to the pressing portion in forming the pressing portion. Accordingly, this structure prevents deterioration of the external appearance of the apparatus.

Moreover, the pressing portion is disposed away from the light guide unit in the radial direction. In this case, the light guide unit and the pressing portion are not overlapped with each other in the axial direction. This structure reduces the thickness of the button, thus achieving space saving.

According to an apparatus of an aspect of various preferred embodiments of the present invention, the first resin may be non-translucent resin, and the second resin may be translucent resin, for example.

According to this aspect, the first resin is non-translucent resin, while the second resin is translucent resin. This structure allows the first molded body and the second molded body to be made of resin in colors different from each other.

According to an apparatus of an aspect of various preferred embodiments of the present invention, a pair of the light guide units may be provided. In this case, a pair of the connecting portions may be provided in correspondence with the pair of light guide units, and the pair of light guide units may be symmetrically disposed with respect to the pressing portion, for example.

According to this aspect, the pair of light guide units is symmetrically disposed with respect to the pressing portion. This structure increases fluidity of material (second resin) in forming the second molded body.

According to an apparatus of an aspect of various preferred embodiments of the present invention, the switch may be a power switch that switches power on-off of the apparatus in accordance with every press of the switch. In this case, the light source may be lit when the apparatus is powered on, and extinguished when the apparatus is powered off, for example.

According to this aspect, the switch constitutes a power switch. In this case, the button can function as a power button.

According to an apparatus of an aspect of various preferred embodiments of the present invention, the apparatus may be a printer that performs printing on a recording medium, for example.

According to this aspect, the apparatus can function as a printer.

A button according to an aspect of various preferred embodiments of the present invention is a button that presses a switch. The button includes a first molded body made of a first resin; and a second molded body made integrally of a second resin different from the first resin. The first molded body includes a button body. The second molded body includes a light guide unit penetrating the button body in an axial direction, along which light guide unit light emitted from a light source is guided toward the outside of the button body; a pressing portion provided to press the switch, disposed at a position away from the light guide unit in a radial direction substantially perpendicular to the axial direction, and projecting from a rear surface of the button body; and a connecting portion disposed on the rear surface of the button body, and connecting the light guide unit and the pressing portion with each other.

According to this aspect, the button body constituting the first molded body is made of a material different from a material of the pressing portion constituting the second molded body. In this case, the button body and the pressing portion are hardened at different timings in forming the button. This structure reduces molding defects produced on the front surface of the button body at a position corresponding to the pressing portion in forming the pressing portion. Accordingly, this structure prevents deterioration of an external appearance of an apparatus including the button.

An apparatus according to various aspects of various preferred embodiments of the present invention is capable of preventing deterioration of the external appearance of the apparatus.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating an external appearance of an apparatus according to a first preferred embodiment of the present invention.

FIG. 2 is an enlarged perspective view illustrating a power button and surroundings of the power button shown in FIG. 1.

FIG. 3 is a cross-sectional view of the apparatus taken along a line A-A in FIG. 2, showing a state before depression of the power button.

FIG. 4 is a cross-sectional view of the apparatus taken along the line A-A in FIG. 2, showing a depressed state of the power button.

FIG. 5 is an exploded perspective view illustrating the power button and a wiring board extracted from the apparatus.

FIG. 6 is an enlarged perspective view illustrating a front surface side of the power button.

FIG. 7 is an enlarged perspective view illustrating a rear surface side of the power button.

FIG. 8 is a view illustrating a part of an external appearance of an apparatus according to a second preferred embodiment of the present invention.

FIG. 9 is a view illustrating a part of an external appearance of an apparatus according to a third preferred embodiment of the present invention.

FIG. 10 is a view illustrating a part of an external appearance of an apparatus according to a fourth preferred embodiment of the present invention.

FIG. 11 is a perspective view illustrating a rear surface side of a conventional power button.

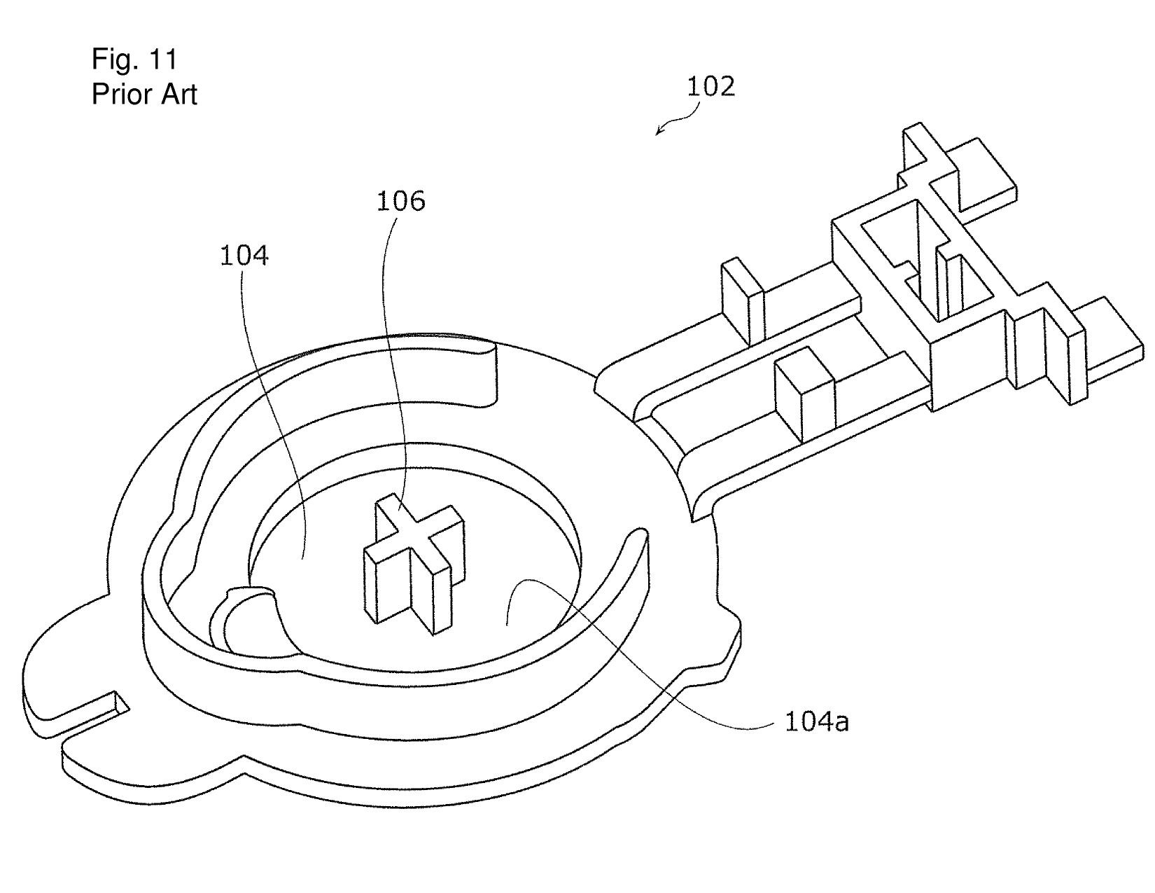

### DETAILED DESCRIPTION OF THE PREFERRED EMBODIMENTS

Preferred embodiments of the present invention are hereinafter described in detail with reference to the drawings. Each of the preferred embodiments presented herein is a preferred specific example of the present invention. Numerical values, shapes, materials, constituent elements, and positions and connection configurations of the constituent elements are presented only by way of example, and not intended to limit the scope of the present invention. The scope of the present invention is only defined by the appended claims. Accordingly, constituent elements contained in the following description of the respective preferred embodiments but not included in the independent claims are not necessarily required in the present invention, and treated as elements realizing more preferable examples of the present invention.

### First Preferred Embodiment

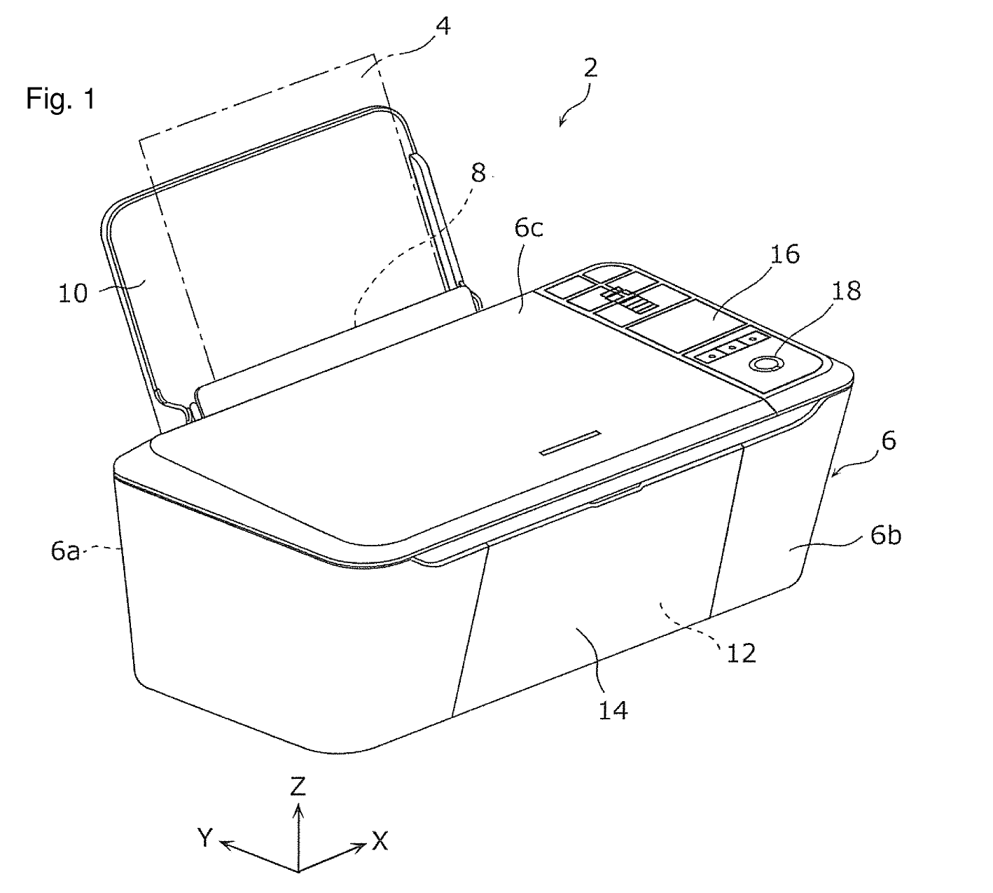

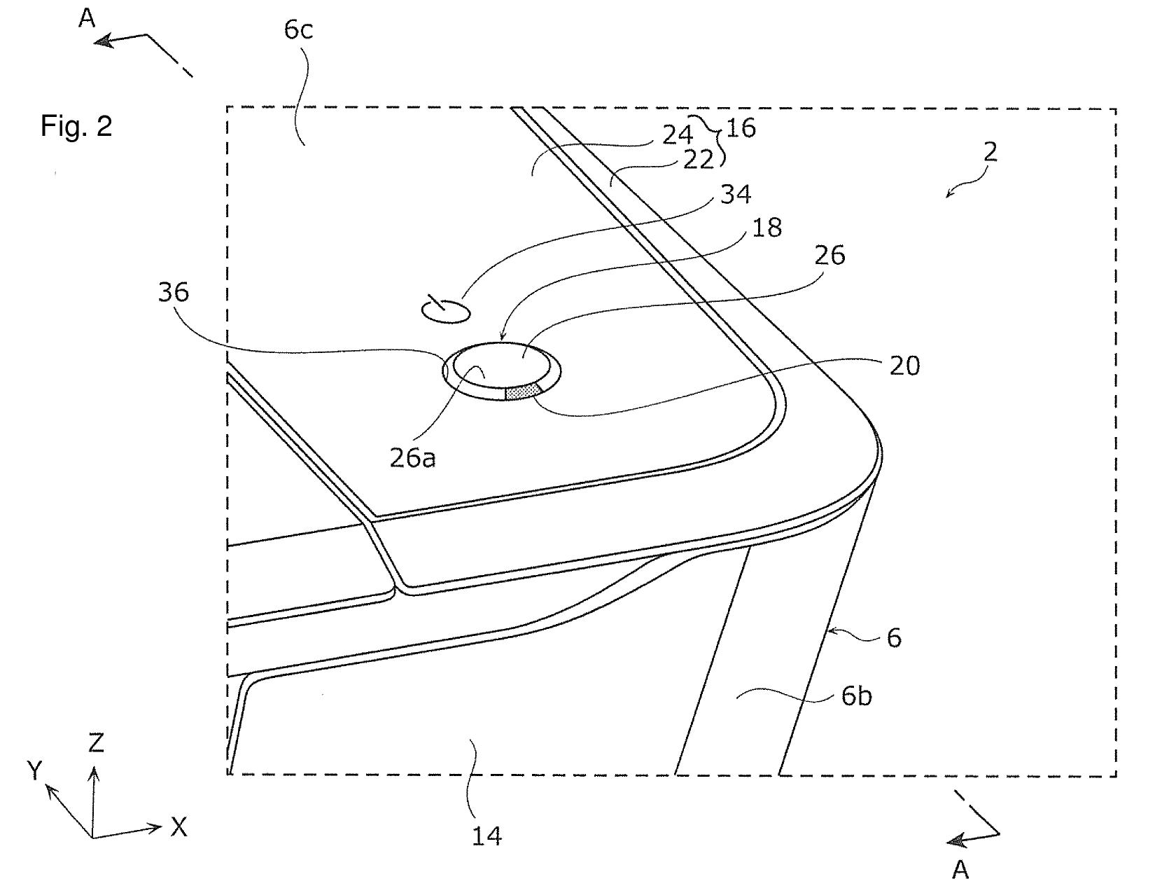

A general configuration of an apparatus 2 according to a first preferred embodiment of the present invention is initially described with reference to FIGS. 1 and 2. FIG. 1 is a perspective view illustrating an external appearance of the apparatus according to the first preferred embodiment. FIG. 2 is an enlarged perspective view illustrating a power button and surroundings of the power button shown in FIG. 1.

As illustrated in FIG. 1, the apparatus 2 is an inkjet printer which ejects ink onto a recording medium 4 to perform printing thereon, for example. The recording medium 4 is plain paper, photographic paper, or a compact disc read only memory (CD-ROM) containing a label surface on which printing is performed, for example.

The apparatus 2 includes a housing 6. A supply port 8 is formed at an upper end of a rear surface 6a of the housing 6. The supply port 8 is a port through which the recording medium 4 for printing is supplied into the housing 6. The recording medium 4 is inserted from above into the supply port 8. A supply tray 10 is further provided at the upper end of the rear surface 6a of the housing 6. The supply tray 10 supports the recording medium 4 from the back when the recording medium 4 is inserted into the supply port 8.

A discharge port 12 is formed in a front surface 6b of the housing 6. The discharge port 12 is an opening through which the recording medium 4 after printing is discharged to the outside of the housing 6. An openable and closable discharge tray 14 is provided at the discharge port 12 to carry the recording medium 4 discharged from the discharge port 12.

An operation panel 16 is provided on an upper surface 6c of the housing 6. The operation panel 16 is a unit operated when operation of the apparatus 2 is performed. As illustrated in FIG. 2, a power button 18 (“button”) disposed on the operation panel 16 is provided in a freely depressible state to turn on or off power of the apparatus 2, for example. Power on-off of the apparatus 2 is switched in accordance with every depression of the power button 18. When the apparatus 2 is powered on, a light guide unit 20 (described later) provided on the power button 18 is lit. When the apparatus 2 is powered off, the light guide unit 20 is extinguished. FIG. 2 illustrates a lit state of the light guide unit 20 of the power button 18. A configuration associated with the power button 18 will be detailed later.

There are further provided, but not shown, a conveying mechanism, a carriage and the like within the housing 6. The conveying mechanism conveys the recording medium 4 supplied into the housing 6 through the supply port 8, in a direction from the inside of the housing 6 toward the discharge port 12. The carriage carries a plurality of replaceable ink cartridges. In printing an image on the recording medium 4, ink filled in each of the plurality of ink cartridges is ejected toward the recording medium 4 under a state that the carriage reciprocates in a direction crossing a conveyance direction of the recording medium 4 substantially at right angles.

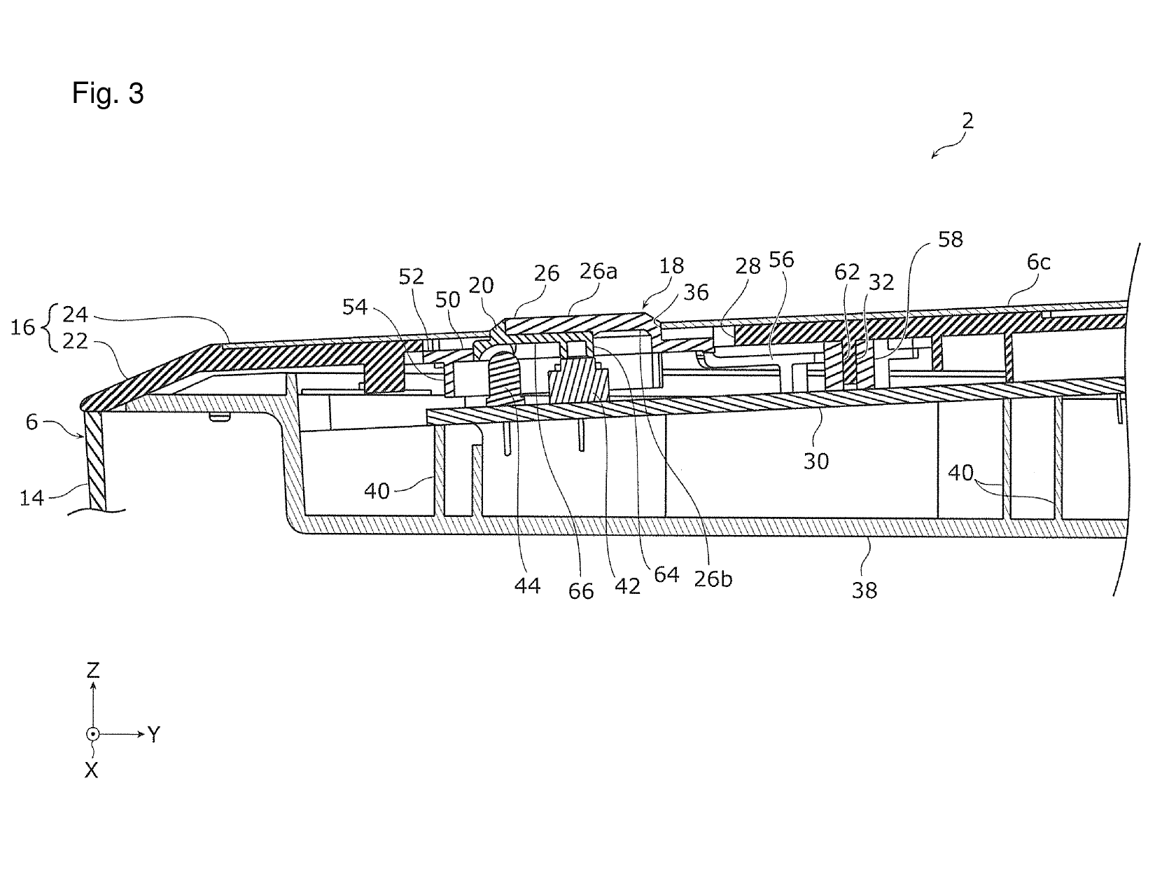

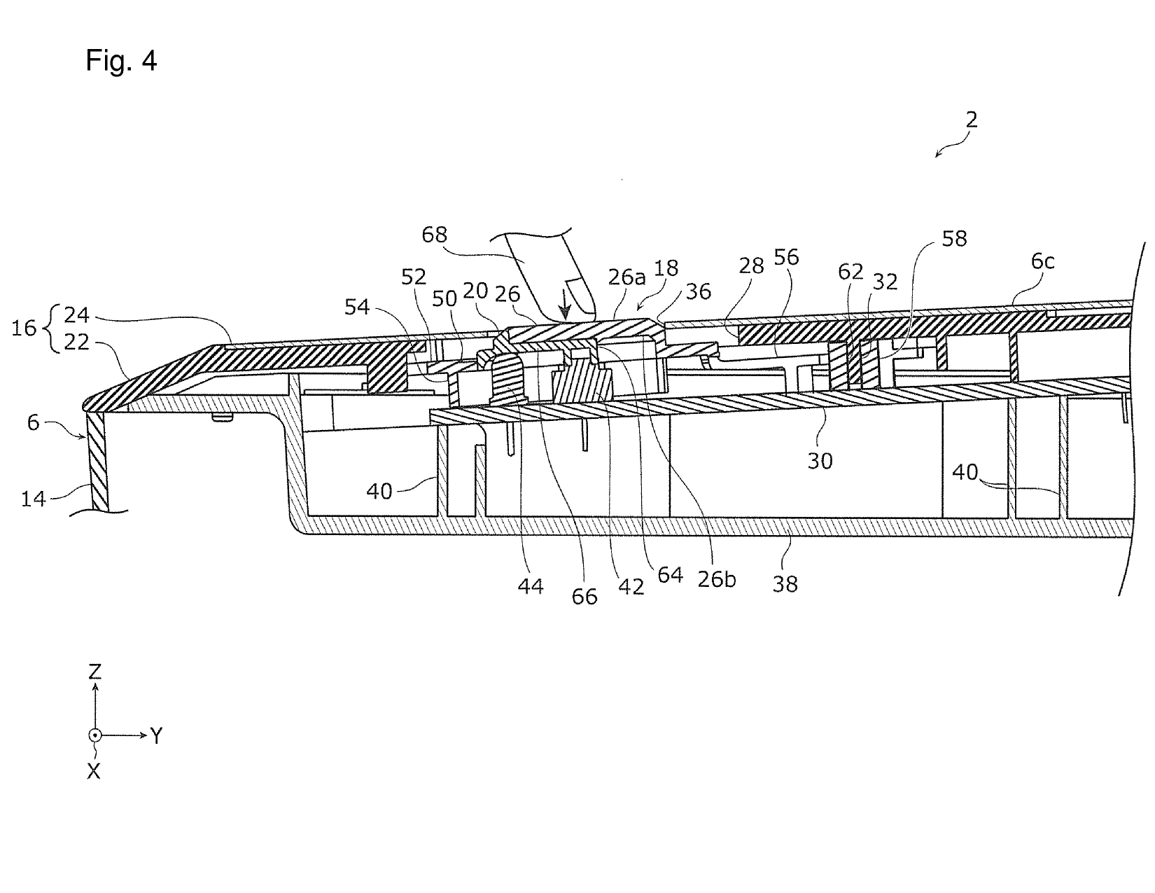

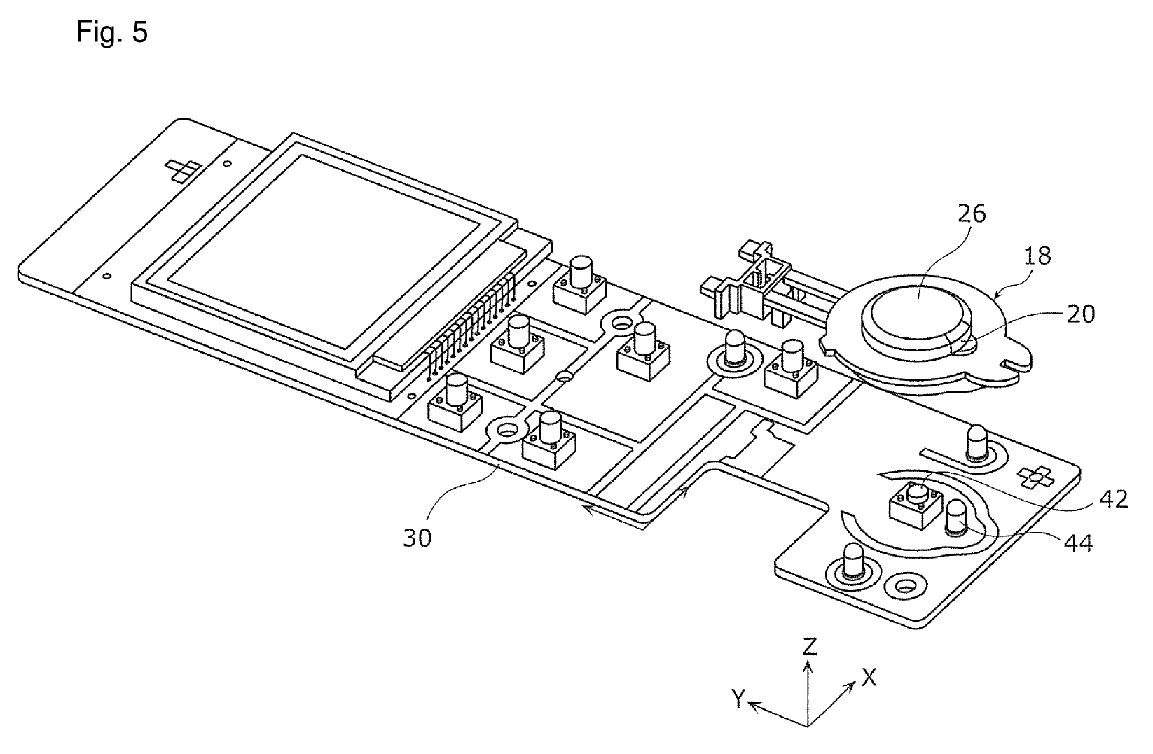

The configuration associated with the power button 18 discussed above is now explained with reference to FIGS. 2 through 7. FIG. 3 is a cross-sectional view of the apparatus taken along a line A-A in FIG. 2, showing a state before depression of the power button. FIG. 4 is a cross-sectional view of the apparatus taken along the line A-A in FIG. 2, showing a depressed state of the power button. FIG. 5 is an exploded perspective view illustrating the power button and a wiring board extracted from the apparatus.

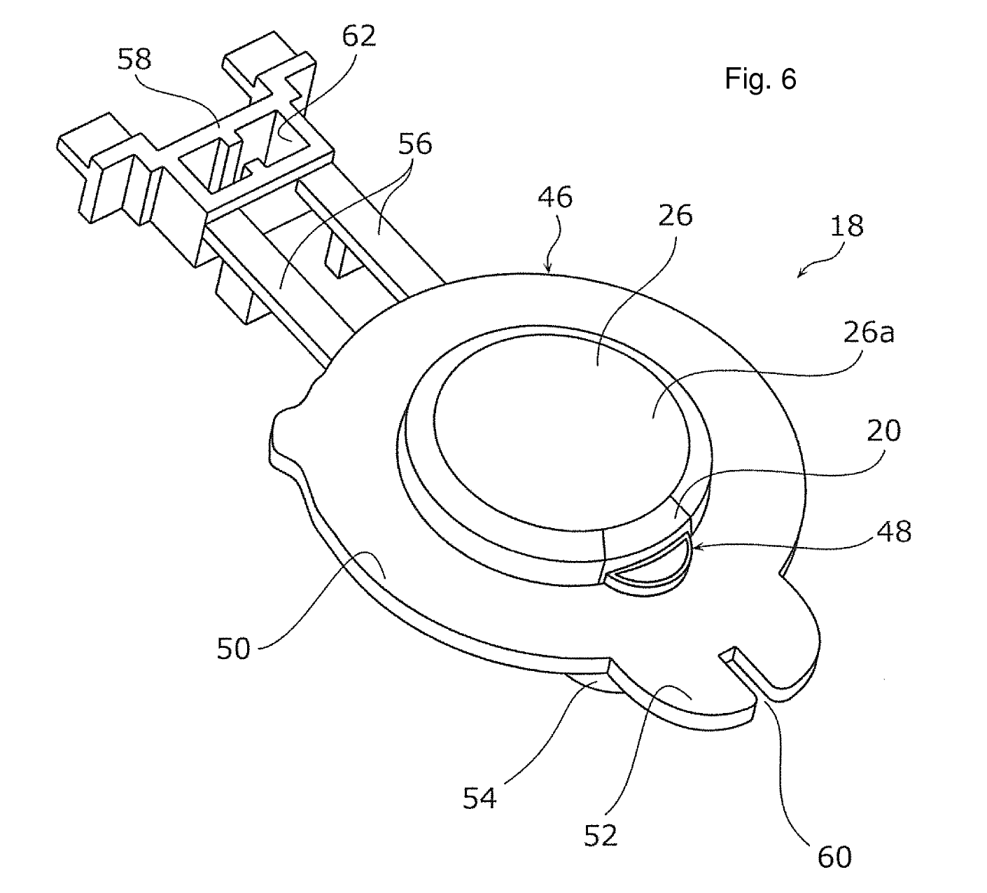

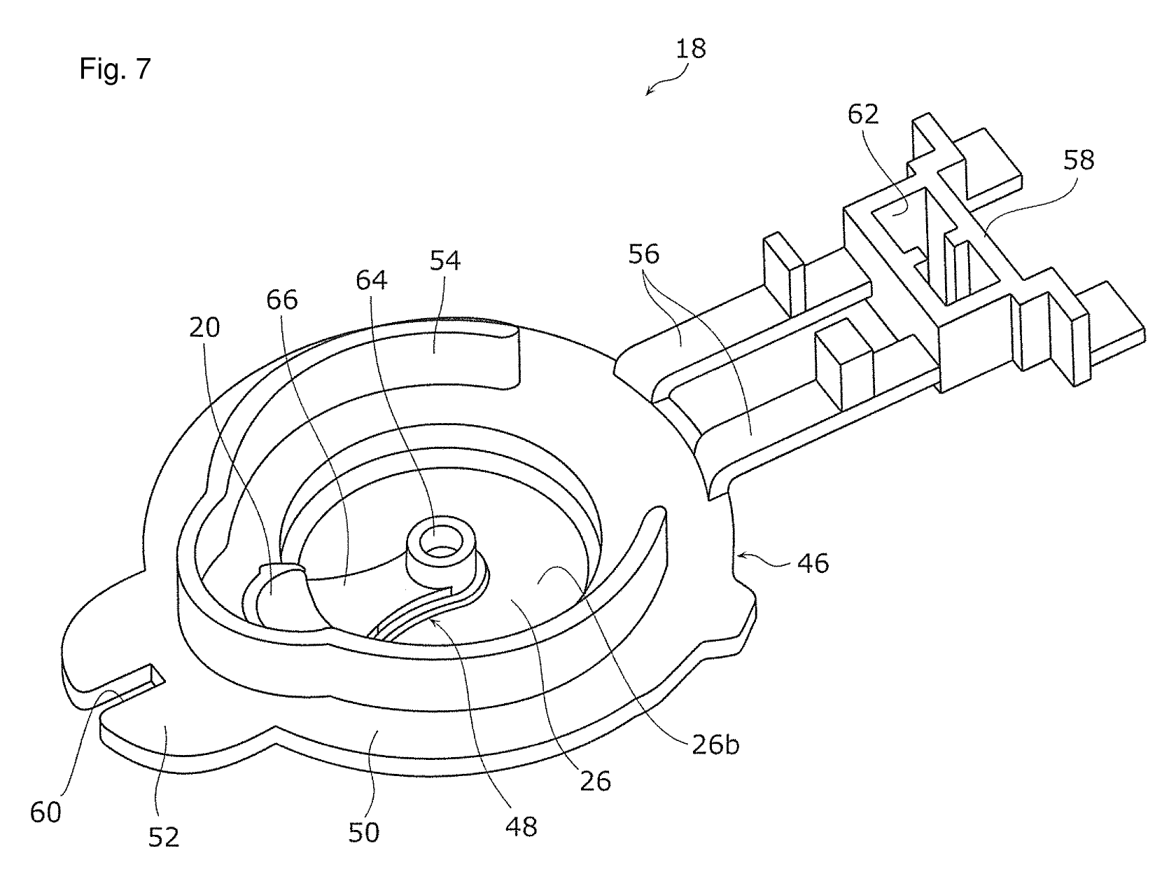

FIG. 6 is an enlarged perspective view illustrating a front surface side of the power button. FIG. 7 is an enlarged perspective view illustrating a rear surface side of the power button.

As illustrated in FIGS. 2 through 4, the operation panel 16 noted above defines the upper surface 6c of the housing 6, and includes a panel frame 22 and a decorative sheet 24. The panel frame 22 has an opening 28 through which a front surface 26a of a button body 26 (described later) of the power button 18 is exposed to the outside of the housing 6. A boss 32 projecting toward a wiring board 30 (described later) is provided on a lower surface of the panel frame 22. The decorative sheet 24 is so disposed as to cover an upper surface of the panel frame 22. A mark 34 indicating the power button 18, for example, is printed on the upper surface of the decorative sheet 24. A circular hole 36 through which the front surface 26a of the button body 26 of the power button 18 is exposed to the outside of the housing 6 is formed at a position corresponding to the opening 28 of the panel frame 22 on the decorative sheet 24.

As illustrated in FIGS. 3 and 4, a support frame 38 for supporting the wiring board 30 is provided within the housing 6. The support frame 38 is so disposed as to face to the lower surface of the panel frame 22. A plurality of posts 40 extending toward the panel frame 22 are provided on an upper surface of the support frame 38.

As illustrated in FIGS. 3 and 4, the wiring board 30 is supported on upper ends of the plurality of posts 40, and disposed in such a position as to face to the panel frame 22. As illustrated in FIG. 5, a plurality of electronic components constituting a control circuit that controls the apparatus 2, such as a tactile switch 42 (“switch”), and a light emitting diode (LED) 44 (“light source”), are mounted on the wiring board 30. The tactile switch 42 is a power switch used to switch power on-off of the apparatus 2. Power on-off of the apparatus 2 is switched in accordance with every press of the tactile switch 42. The LED 44 preferably is a shell-type LED, for example. The LED 44 is lit when the apparatus 2 is powered on, and extinguished when the apparatus 2 is powered off.

A structure of the power button 18, corresponding to a feature of the apparatus 2 according to this preferred embodiment, is now described with reference to FIGS. 6 and 7. As illustrated in FIGS. 6 and 7, the power button 18 is a button which presses the tactile switch 42 discussed above, and includes a first molded body 46 and a second molded body 48. The first molded body 46 is an integrally molded body made of a non-translucent resin (a first resin). On the other hand, the second molded body 48 is an integrally molded body made of a translucent resin (a second resin different from the first resin). In molding the power button 18, the first molded body 46 is initially formed by using the non-translucent resin. Then, the second molded body 48 is formed by using the translucent resin after the first molded body 46 is hardened. In the context of this specification, the non-translucent resin refers to an opaque resin, while the translucent resin refers to a transparent or semi-transparent resin.

The first molded body 46 includes the button body 26, a flange portion 50, a regulation portion 52, a rib portion 54, a pair of flat spring portions 56, and a support portion 58. The button body 26 has a circular or substantially circular-cap shape in the top view. The front surface 26a of the button body 26 has a flat shape. The flange portion 50 has a circular or substantially circular shape in the top view, and extends outwardly in a radial direction from an outer peripheral edge of the button body 26 (i.e., a direction parallel or substantially parallel with the front surface 26a of the button body 26). The regulation portion 52 extends farther outwardly in the radial direction from an outer peripheral edge of the flange portion 50, and includes a slit 60. The rib portion 54 is provided on a rear surface of the flange portion 50, and extends along the outer peripheral edge of the flange portion 50. Each of the pair of flat spring portions 56 extends outwardly in the radial direction from a position of the outer peripheral edge of the button body 26 on the side opposite to the regulation portion 52. The support portion 58 is provided at ends of the pair of flat spring portions 56, and includes a through hole 62 extending in an axial direction (i.e., a direction perpendicular or substantially perpendicular to the front surface 26a of the button body 26 and perpendicular or substantially perpendicular to the radial direction).

The second molded body 48 includes the light guide unit 20, a pressing portion 64, and a connecting portion 66. The light guide unit 20 penetrates the outer periphery of the button body 26 in the axial direction. The pressing portion 64 is spaced away from the light guide unit 20 in the radial direction, and projected toward the tactile switch 42 from the central portion of a rear surface 26b (surface on the side opposite to the front surface 26a) of the button body 26. The connecting portion 66 is disposed on the rear surface 26b of the button body 26 to connect the light guide unit 20 and the pressing portion 64 with each other.

Arrangement of the power button 18 is now described with reference to FIGS. 2 through 5. As illustrated in FIGS. 3 and 4, the power button 18 is disposed between the panel frame 22 and the wiring board 30. By insertion of the boss 32 of the panel frame 22 into the through hole 62 of the support portion 58, the power button 18 is brought into a condition supported on the panel frame 22 in a freely depressible state. Accordingly, the button body 26 is supported in a freely movable state in both directions of moving closer to and away from the tactile switch 42 (i.e., axial direction noted above). The tactile switch 42 is disposed immediately below the pressing portion 64, while the LED 44 is disposed immediately below the light guide unit 20.

Each of the button body 26 and the flange portion 50 is disposed at the opening 28 of the panel frame 22. As illustrated in FIGS. 2 through 4, the front surface 26a of the button body 26 is exposed to the outside of the housing 6 through the hole 36 of the decorative sheet 24. A projecting side (not shown) formed on the lower surface of the panel frame 22 is inserted into the slit 60 of the regulation portion 52. This structure regulates a horizontal slip of the power button 18 in the radial direction. In addition, the rib portion 54 extends along the outer peripheral edge of the flange portion 50, wherefore a long creepage distance is secured for static electricity entering the inside of the housing 6 through a clearance between the button body 26 and the hole 36.

When the button body 26 of the power button 18 is in the not-depressed state as illustrated in FIG. 3, the pressing portion 64 only contacts the tactile switch 42 without applying pressure on the tactile switch 42. In this state, a clearance is provided between the light guide unit 20 and the LED 44. In addition, each of the pair of flat spring portions 56 is not bended.

When a user depresses the button body 26 of the power button 18 by a finger 68 in a power-off state of the apparatus 2 as illustrated in FIG. 4, the tactile switch 42 is pressed by the pressing portion 64. As a result, the apparatus 2 is powered on, and the LED 44 is lit. The light emitted from the LED 44 is guided by the light guide unit 20 toward the outside of the housing 6, such that the light guide unit 20 is lit as illustrated in FIG. 2.

In the depressed state of the button body 26 as illustrated in FIG. 4, each of the pair of flat spring portions 56 elastically bends. When the finger 68 is separated from the button body 26 in this condition, the button body 26 returns to the state illustrated in FIG. 3 by each elastic restoring force of the pair of flat spring portions 56.

On the other hand, when the button body 26 of the power button 18 is depressed by the user using the finger 68 as illustrated in FIG. 4 in the power-on state of the apparatus 2, the tactile switch 42 is pressed by the pressing portion 64. As a result, the apparatus 2 is powered off, and the LED 44 is extinguished. Simultaneously, the light guide unit 20 is extinguished.

Advantageous effects achieved by the apparatus 2 according to this preferred embodiment are now explained. The button body 26 constituting the first molded body 46 is made of a material different from a material of the pressing portion 64 constituting the second molded body 48. In this case, the button body 26 and the pressing portion 64 are hardened at different timings in forming the power button 18. This structure reduces molding defects produced on the front surface 26a of the button body 26 at a position corresponding to the pressing portion 64 in forming the pressing portion 64.

Moreover, the pressing portion 64 is spaced away from the light guide unit 20 in the radial direction. In this case, the light guide unit 20 and the pressing portion 64 are not overlapped with each other in the axial direction. This structure reduces the thickness of the power button 18 in the Z-axis direction, thus achieving space saving.

### Second Preferred Embodiment

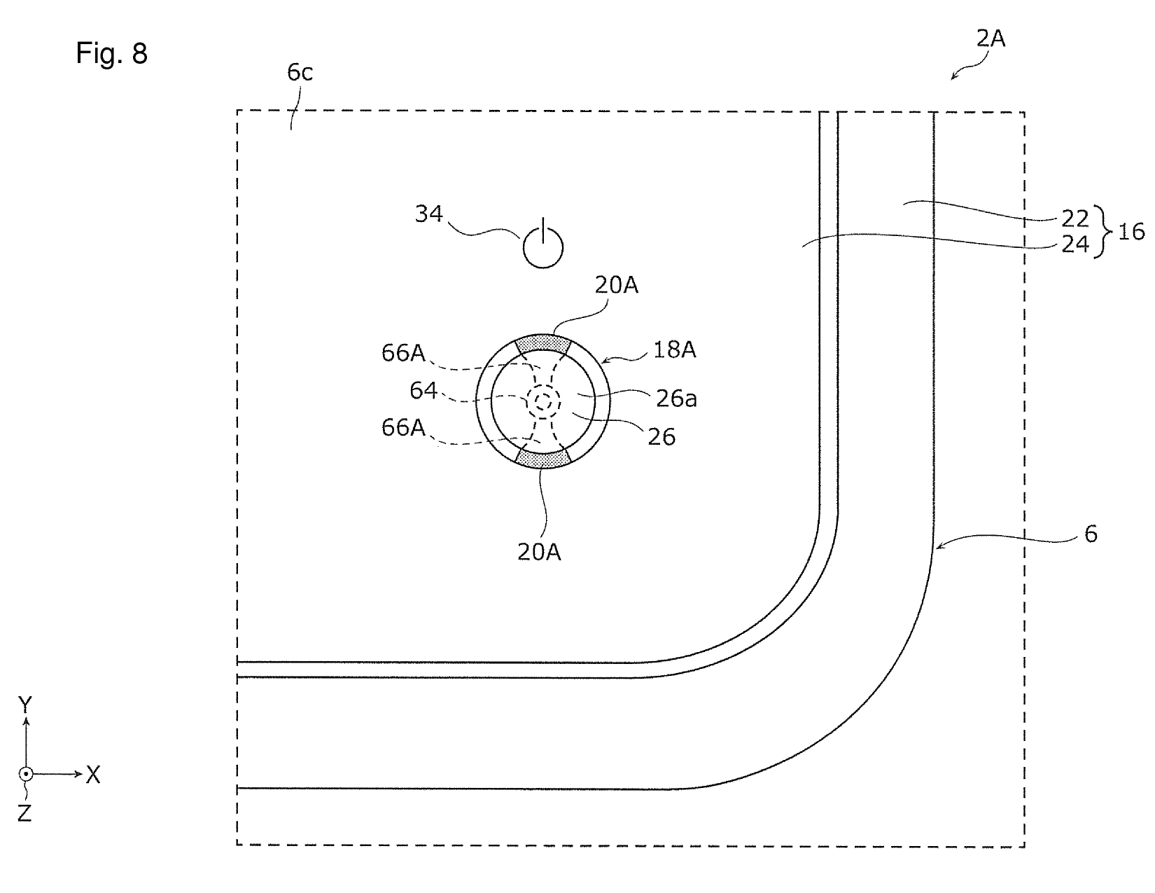

A configuration of an apparatus 2A according to a second preferred embodiment of the present invention is hereinafter described with reference to FIG. 8. FIG. 8 illustrates a portion of an external appearance of the apparatus according to the second preferred embodiment. Constituent elements similar to the corresponding constituent elements in the first preferred embodiment have been given similar reference numbers, and the same explanation is not repeated.

As illustrated in FIG. 8, a power button 18A of the apparatus 2A according to this preferred embodiment includes a pair of light guide units 20A. A pair of connecting portions 66A is provided in correspondence with the pair of light guide units 20A. The pair of light guide units 20A is symmetrically disposed with respect to the pressing portion 64. This structure increases fluidity of material in forming a second molded body of the power button 18A.

### Third Preferred Embodiment

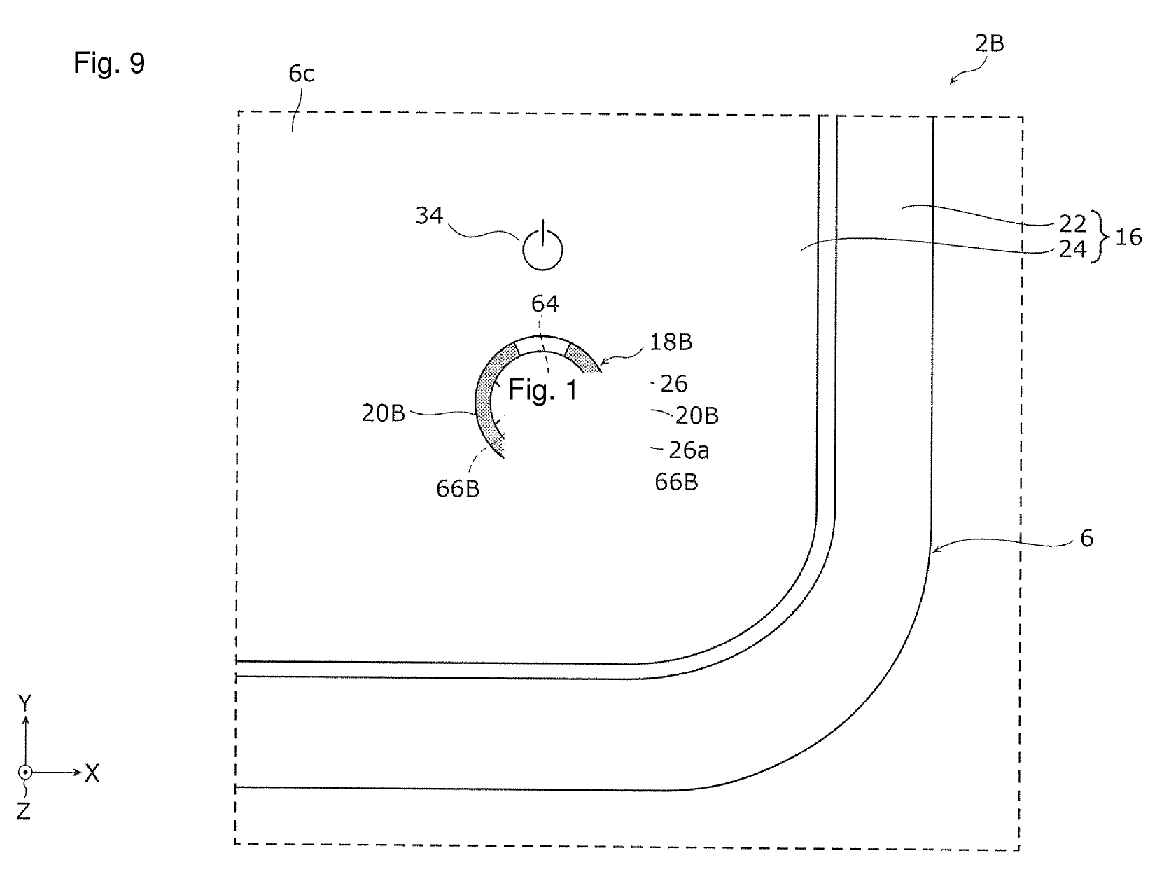

A configuration of an apparatus 2B according to a third preferred embodiment of the present invention is hereinafter described with reference to FIG. 9. FIG. 9 illustrates a portion of an external appearance of the apparatus according to the third preferred embodiment.

As illustrated in FIG. 9, a power button 18B of the apparatus 2B according to this preferred embodiment includes a pair of light guide units 20B. A pair of connecting portions 66B is provided in correspondence with the pair of light guide units 20B. The pair of light guide units 20B is symmetrically disposed with respect to the pressing portion 64. This structure increases fluidity of material in forming a second molded body of the power button 18B.

### Fourth Preferred Embodiment

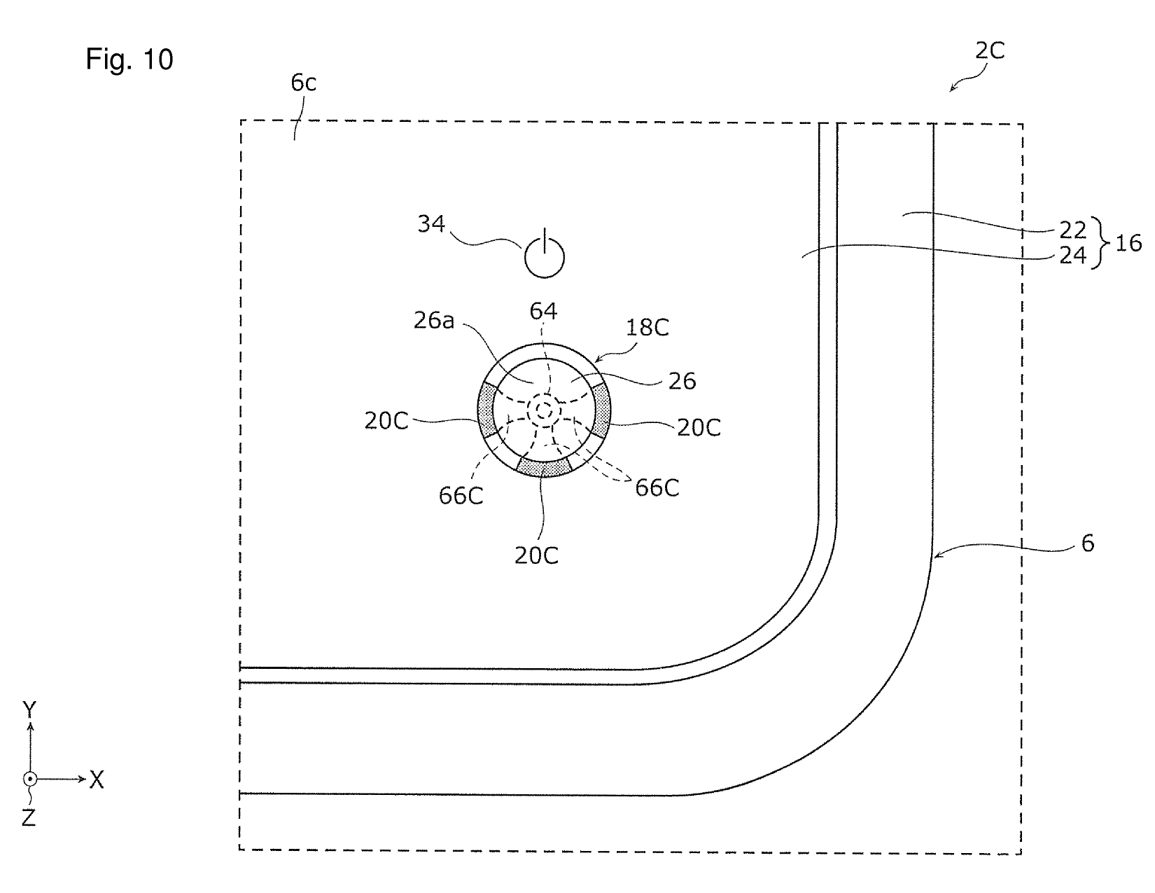

A configuration of an apparatus 2C according to a fourth preferred embodiment of the present invention is hereinafter described with reference to FIG. 10.

FIG. 10 illustrates a part of an external appearance of the apparatus according to the fourth preferred embodiment.

As illustrated in FIG. 10, a power button 18C of the apparatus 2C according to this preferred embodiment includes a plurality of (three) light guide units 20C. A plurality of (three) connecting portions 66C are provided in correspondence with the plurality of light guide units 20C. The plurality of light guide units 20C is asymmetrically disposed with respect to the pressing portion 64. This structure provides advantages similar to the advantages of the first preferred embodiment.

### Modified Example

The present invention is not limited to the apparatus and the button according to the first through fourth preferred embodiments of the present invention described herein. For example, the first through fourth preferred embodiments may be arbitrarily combined.

According to the foregoing preferred embodiments, the apparatus 2 (or 2A through 2C) preferably is constituted by an inkjet printer. However, rather than an inkjet printer, the apparatus 2 (or 2A through 2C) may be constituted by various types of consumer products, such as a laser printer or other types of printers, a multifunction machine, a facsimile machine, a telephone, a personal computer, a television, a recording device, a game machine, an intercom, a refrigerator, and a washing machine. Alternatively, the apparatus 2 (or 2A through 2C) may be constituted by various types of industrial equipment, such as a lathe, an inspection device, a press device, and a cutting device.

According to the foregoing preferred embodiments, the button according to the present invention preferably is constituted by the power button 18 (or 18A through 18C). However, the button may be constituted by a recording start button when the apparatus 2 (or 2A through 2C) is a recording device.

According to the foregoing preferred embodiments, the whole of the front surface 26a of the button body 26 preferably is exposed to the outside of the housing 6. However, only a portion of the front surface 26a may be exposed to the outside of the housing 6.

An apparatus according to various preferred embodiments of the present invention is applicable to an inkjet printer which ejects ink onto a recording medium to perform printing on the recording medium, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An apparatus comprising:
a housing that includes a hole;
a switch disposed within the housing; and
a button provided to press the switch, and including a first body made of a first material, and a second body made of a second material; wherein
an exposed surface is disposed such that at least a portion of the first and second bodies is exposed to outside of the housing through the hole;
the second body is disposed on a rear surface of the first body; and
the second body is provided to press the switch based on pressing the exposed surface.

2. The apparatus according to claim 1, further comprising a light source disposed within the housing.

3. The apparatus according to claim 1, wherein the first material is a first molded resin, and the second material is a second molded resin different from the first molded resin.

4. The apparatus according to claim 2, wherein the first body includes a button body supported in a state movable in an axial direction corresponding to directions of moving closer toward and away from the switch, and disposed such that at least a portion of a front surface of the button body is exposed to outside of the housing through the hole; and
the second body includes:
a light guide unit penetrating the button body in the axial direction, along which light guide unit light emitted from the light source is guided toward the outside of the housing;
a pressing portion provided to press the switch, disposed at a position spaced away from the light guide unit in a radial direction perpendicular or substantially perpendicular to the axial direction, and projecting toward the switch from a rear surface of the button body; and
a connecting portion disposed on the rear surface of the button body, and connecting the light guide unit and the pressing portion with each other.

5. The apparatus according to claim 1, wherein
the first material is a non-translucent resin; and
the second material is a translucent resin.

6. The apparatus according to claim 4, wherein
a pair of the light guide units is provided;
a pair of the connecting portions is provided in correspondence with the pair of light guide units; and
the pair of light guide units is symmetrically disposed with respect to the pressing portion.

7. The apparatus according to claim 2, wherein
the switch is a power switch that switches power on-off of the apparatus in accordance with every press of the switch; and
the light source is lit when the apparatus is powered on, and extinguished when the apparatus is powered off.

8. The apparatus according to claim 1, wherein the apparatus is a printer that performs printing on a recording medium.

9. The apparatus according to claim 1, wherein the apparatus is one of an inkjet printer, a laser printer, a multifunction machine, a facsimile machine, a telephone, a personal computer, a television, a recording device, a game machine, an intercom, a refrigerator, a washing machine, a lathe, an inspection device, a press device, and a cutting device.

10. The apparatus according to claim 1, wherein the switch is a tactile switch.

11. The apparatus according to claim 2, wherein the light source is an LED.

12. The apparatus according to claim 1, wherein
the first material is an opaque resin; and
the second material is a transparent or semi-transparent resin.

13. The apparatus according to claim 4, wherein
three or more of the light guide units are provided;
three or more of the connecting portions are provided in correspondence with the pair of light guide units; and
the three or more light guide units are symmetrically disposed with respect to the pressing portion.

14. A button that presses a switch, the button comprising:
a first molded body made of a first resin; and
a second molded body made integrally of a second resin different from the first resin; wherein
the first molded body includes a button body; and
the second molded body includes:
a light guide unit penetrating the button body in an axial direction, along which light guide unit light emitted from a light source is guided toward an outside of the button body;
a pressing portion provided to press the switch, disposed at a position spaced away from the light guide unit in a radial direction perpendicular or substantially perpendicular to the axial direction, and projecting from a rear surface of the button body; and
a connecting portion disposed on the rear surface of the button body, and connecting the light guide unit and the pressing portion with each other.

15. The button according to claim 14, wherein
the first resin is a non-translucent resin, and
the second resin is a translucent resin.

16. The button according to claim 14, wherein
the first resin is an opaque resin; and
the second resin is a transparent or semi-transparent resin.

17. The button according to claim 14, wherein the button is a power button that switches power on-off of an apparatus.

18. The button according to claim 14, wherein the button is a recording start button.

19. The button according to claim 14, wherein the first molded body includes a flange portion, a regulation portion, a rib portion, a pair of flat spring portions and a support portion.

20. The button according to claim 14, wherein the button body has a circular or substantially circular-cap shape.
